(19) United States
(12) Patent Application Publication
(10) Pub. No.: US 2023/0286610 A1
(43) Pub. Date: Sep. 14, 2023

(54) SCOOTER TYPE ELECTRIC VEHICLE

(71) Applicant: YAMAHA HATSUDOKI KABUSHIKI KAISHA, Iwata-shi (JP)

(72) Inventors: Hiroyuki TSURUHASHI, Shizuoka (JP); Takashi SATO, Shizuoka (JP); Torao MATSUZAWA, Shizuoka (JP)

(21) Appl. No.: 18/118,164

(22) Filed: Mar. 7, 2023

(30) Foreign Application Priority Data
Mar. 8, 2022 (JP) 2022-035400

(51) Int. Cl. B62M 7/12; B62K 11/02; B60K 1/04; B60K 7/00

(52) U.S. Cl. CPC B62M 7/12; B62K 11/02; B60K 1/04; B60K 7/0007; B62K 2202/00; B60K 2001/0422; B60L 2210/10

(57) ABSTRACT

An electric scooter includes a front wheel and a rear wheel, an electric motor, a floorboard between the front and rear wheels, a seat behind and diagonally above the floorboard, a container box below the seat and including a first front wall, a first left side wall, and a first right side wall, a cover including a second front wall covering the first front wall, a second left side wall covering the first left side wall, and a second right side wall covering the first right side wall, and a first electrical component between the first and second front walls, a second electrical component between the first and second left side walls, and a third electrical component between the first and second right side walls.

### CROSS REFERENCE TO RELATED APPLICATIONS

This application claims the benefit of priority to Japanese Patent Application No. 2022-035400 filed on Mar. 8, 2022. The entire contents of this application are hereby incorporated herein by reference.

### BACKGROUND OF THE INVENTION

### 1. Field of the Invention

The present invention relates to scooter type electric vehicles that are powered by an electric motor to travel.

### 2. Description of the Related Art

There are some scooter type two-wheeled electric vehicles that have an electric motor as a source of power for traveling (see, for example, Japanese Laid-Open Patent Publication No. 2000-253591).

The electric motor rotates due to electric power supplied from a battery mounted on the vehicle. The rotation of the electric motor is transmitted to a wheel thus allowing the vehicle to travel.

A scooter type two-wheeled electric vehicle is equipped with various parts including electrical components. However, in a scooter type two-wheeled electric vehicle, a number of parts need to be arranged within a limited space in the body of the vehicle, and therefore, it is not easy to allocate a space to arrange the electrical components.

There has been a demand for further improvement to the arrangement of electrical components in a scooter type electric vehicle.

### SUMMARY OF THE INVENTION

An electric scooter according to a preferred embodiment of the present invention includes a front wheel and a rear wheel, an electric motor to receive power from a battery and to drive at least one of the front wheel or the rear wheel, a floorboard between the front wheel and the rear wheel, a seat behind and diagonally above the floorboard, a container box below the seat and including a first front wall, a first left side wall, and a first right side wall, a cover including a second front wall covering the first front wall, a second left side wall covering the first left side wall, and a second right side wall covering the first right side wall, and a first electrical component located between the first front wall and the second front wall, a second electrical component located between the first left side wall and the second left side wall, and a third electrical component located between the first right side wall and the second right side wall.

If an attempt is made to arrange a plurality of electrical components that are mounted on an electric scooter all in one place, it is necessary to allocate in the vehicle a large space to arrange the plurality of electrical components together. According to a preferred embodiment of the present invention, a plurality of electrical components are arranged at distributed positions including a position between the first front wall of the container box and the second front wall of the cover, a position between the first left side wall of the container box and the second left side wall of the cover, and a position between the first right side wall of the container box and the second right side wall of the cover. Therefore, it is not necessary to allocate in the vehicle a large space to arrange a plurality of electrical components all in one place. By utilizing spaces between the container box and the cover, a slim volume is able to accommodate all of the electrical components.

A plurality of electrical components are distributed and arranged around the container box so that a distance between each electrical component is relatively short. Therefore, the length of an electrical cable connecting each electrical component is reduced. For example, as a large current flows through an electrical component that is provided on an electrical path between the battery and the electric motor, an electrical cable connected to such electrical components has a large cross-sectional area. By providing a plurality of electrical components around the container box, the lengths of electrical cables having a large cross-sectional area are reduced, resulting in a reduction in space to arrange the electrical cables. The reduction in the length of an electrical cable having a large cross-sectional area leads to a reduction in weight and cost.

As electrical components are located around the container box, i.e., at a relatively high position, the electrical components are less likely to get wet even if water on the road surface enters the vehicle.

In a preferred embodiment, the battery may be located in the container box.

As a large current flows through an electrical cable that connects the battery and an electrical component, the electrical cable has a large cross-sectional area. By providing a plurality of electrical components around the container box, the lengths of electrical cables having a large cross-sectional area that connect the battery and the electrical components are reduced.

In a preferred embodiment, the battery may be removably attached to the electric scooter.

The battery is able to be charged by being connected to an external charger with the battery removed from the vehicle. For example, even when no charging equipment is provided in a parking garage, the battery is able to be charged.

In a preferred embodiment, the first electrical component, the second electrical component, and the third electrical component may have different functions.

As it is not necessary to allocate in the vehicle a large space to arrange a plurality of electrical components having different functions all in one place, a slim volume is able to accommodate all of the electrical components.

In a preferred embodiment, the first electrical component, the second electrical component, and the third electrical component may each be any of a controller configured or programmed to control an operation of the electric scooter, a converter to change a magnitude of an output voltage of the battery and output the resultant voltage, a battery switcher to switch batteries for use, a positioner to detect a location of the electric scooter in a geographic coordinate system, and a communicator to communicate data between the electric scooter and an external device.

It is not necessary to allocate in the vehicle a large space to arrange a plurality of electrical components all in one place, and a slim volume is able to accommodate all of the electrical components.

In a preferred embodiment, the first electrical component located between the first front wall and the second front wall may be thicker than the second electrical component and the third electrical component.

It is relatively easy to increase a distance between the first front wall and the second front wall. Therefore, by locating an electrical component having a greatest thickness in front of the container box, a width in a leftward/rightward direction of the cover covering the container box is reduced.

In a preferred embodiment, the electric scooter may further include a frame extending between the first left side wall and the second left side wall and between the first right side wall and the second right side wall. At least one of the second electrical component or the third electrical component may be located inward of the frame in a width direction of the electric scooter.

Even if an external force is applied to a side portion of the electric scooter, the external force is substantially prevented from being applied to an electrical component.

In a preferred embodiment, the electric scooter may further include a frame extending between the first left side wall and the second left side wall and between the first right side wall and the second right side wall. At least one of the second electrical component or the third electrical component may be located on the frame.

The second electrical component and the third electrical component are easily located between the container box and the cover.

In a preferred embodiment, at least one of the second electrical component or the third electrical component may be located at or behind a center portion of the container box in a forward/rearward direction of the electric scooter.

A front left diagonal portion and a front right diagonal portion of the cover covering the container box is reduced in size, and therefore, a portion for the rider's feet of the electric scooter is able to have a simple design.

In a preferred embodiment, the electric scooter may further include a frame extending between the first left side wall and the second left side wall and between the first right side wall and the second right side wall. The frame extends rearward and diagonally upward at a position lateral to the container box. At least one of the second electrical component or the third electrical component may be located on the frame at or behind the center portion of the container box in a forward/rearward direction of the electric scooter.

A front left diagonal portion and a front right diagonal portion of the cover covering the container box is reduced in size, and therefore, a portion for the rider's feet of the electric scooter is able to have a simple design.

The second electrical component and the third electrical component are able to be located at a higher position. Therefore, the second electrical component and the third electrical component are less likely to get wet even if water on the road surface enters the vehicle.

In a preferred embodiment, the electric scooter may further include a swingarm that supports the rear wheel. The electric motor may be provided on the swingarm.

As it is not necessary to allocate a space to arrange the electric motor in the inside of the vehicle body of the electric scooter, the flexibility of arranging parts other than the electric motor is increased.

In a preferred embodiment, the electric scooter may be a scooter two-wheeled electric vehicle.

In a scooter two-wheeled electric vehicle, a number of parts need to be arranged within a limited space in the vehicle, and therefore, a limitation is imposed on the arrangement of the parts. According to a preferred embodiment of the present invention, a plurality of electrical components are arranged at distributed positions including a position between the first front wall of the container box and the second front wall of the cover, a position between the first left side wall of the container box and the second left side wall of the cover, and a position between the first right side wall of the container box and the second right side wall of the cover. By utilizing spaces between the container box and the cover, a slim volume is able to accommodate all of the electrical components.

According to a preferred embodiment of the present invention, a plurality of electrical components are arranged at distributed positions including a position between the first front wall of the container box and the second front wall of the cover, a position between the first left side wall of the container box and the second left side wall of the cover, and a position between the first right side wall of the container box and the second right side wall of the cover. Therefore, it is not necessary to allocate in the vehicle a large space to arrange a plurality of electrical components all in one place. By utilizing spaces between the container box and the cover, a slim volume is able to accommodate all of the electrical components.

A plurality of electrical components are distributed and arranged around the container box so that a distance between each electrical component is relatively short. Therefore, the length of an electrical cable connecting between each electrical component is reduced. For example, as a large current flows through an electrical component that is provided on an electrical path between the battery and the electric motor, an electrical cable connected to such electrical components has a large cross-sectional area. By providing a plurality of electrical components around the container box, the lengths of electrical cables having a large cross-sectional area are reduced, resulting in a reduction in a space to arrange the electrical cables. The reduction in the length of an electrical cable having a large cross-sectional area leads to a reduction in weight and cost.

As electrical components are located around the container box, i.e., at a relatively high position, the electrical components are less likely to get wet even if water on the road surface enters the vehicle.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a left side view illustrating a scooter type electric vehicle 1 according to a preferred embodiment of the present invention.

FIG. 2 is a left side view illustrating a vehicle body frame 30 and a container box 10 according to a preferred embodiment of the present invention.

FIG. 3 is a perspective view of a vehicle body frame 30 and a container box 10 according to a preferred embodiment of the present invention as viewed diagonally from the left front.

FIG. 4 is a perspective view of a vehicle body frame 30 and a container box 10 according to a preferred embodiment of the present invention as viewed diagonally from the right front.

FIG. 5 is a diagram illustrating a container box 10 with batteries 51 and 52 contained therein according to a preferred embodiment of the present invention.

FIG. 6 is a block diagram illustrating an example of a plurality of electrical components provided in a scooter type electric vehicle 1 according to a preferred embodiment of the present invention.

FIG. 7 is a diagram illustrating a container box 10, a seat cowling 23, and a rear cowling 24 according to a preferred embodiment of the present invention.

### DETAILED DESCRIPTION OF THE PREFERRED EMBODIMENTS

Preferred embodiments of the present invention will be described below with reference to the accompanying drawings. In the description of the preferred embodiments, like elements or features are indicated by like reference characters and will not be redundantly described. The front and rear, top and bottom, and left and right of a scooter type electric vehicle each have a meaning that is defined in relation to a rider who is sitting on the seat of the vehicle. The preferred embodiments below are merely for illustrative purposes, and the present invention is not limited to the preferred embodiments below.

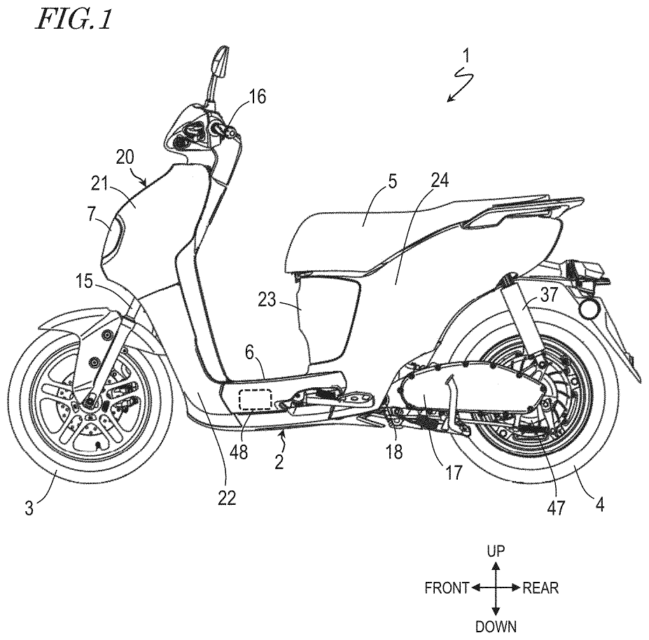

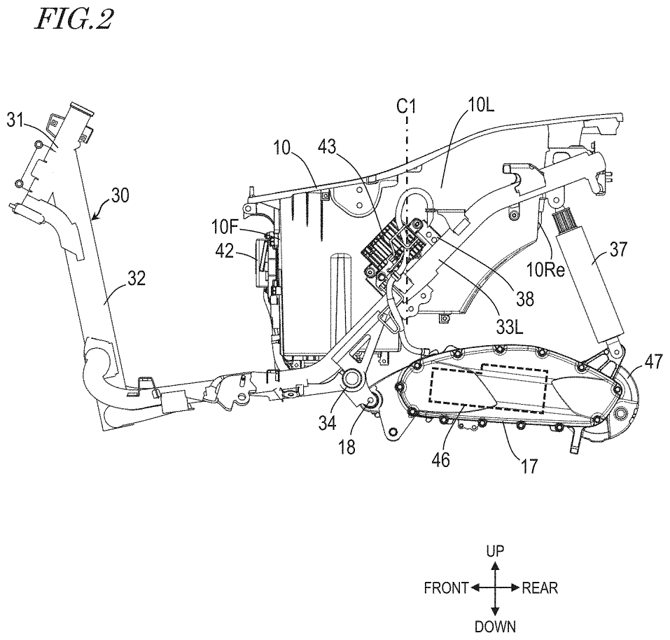

FIG. 1 is a left side view illustrating a scooter type electric vehicle 1 according to a preferred embodiment of the present invention. In the example illustrated in FIG. 1, the vehicle 1 is a scooter type two-wheeled electric vehicle. The vehicle 1 may be a scooter type electric vehicle with three or more wheels. An example in which the vehicle 1 is a scooter type two-wheeled electric vehicle will be described below. FIG. 2 is a left side view illustrating a vehicle body frame 30 and a container box 10 included in the scooter type two-wheeled electric vehicle 1.

The scooter type two-wheeled electric vehicle 1 includes a vehicle body 2, a front wheel 3, and a rear wheel 4. The vehicle body 2 has a structure including a vehicle body frame 30 (FIG. 2) and a vehicle body cover 20 (FIG. 1) covering at least a portion of the vehicle body frame 30. The vehicle body frame 30 is, for example, an underbone frame. The vehicle body frame 30 includes a head pipe 31 and a main frame 32. A steering shaft is inserted in the head pipe 31. A steering handlebar 16 is provided at an upper end of the steering shaft. A front fork 15 is provided at a lower end of the steering shaft. The front wheel 3 is rotatably supported at a lower end of the front fork 15.

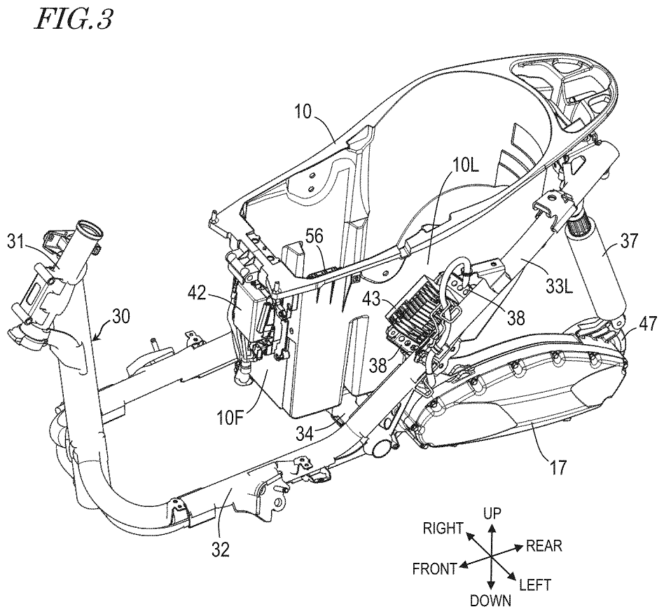

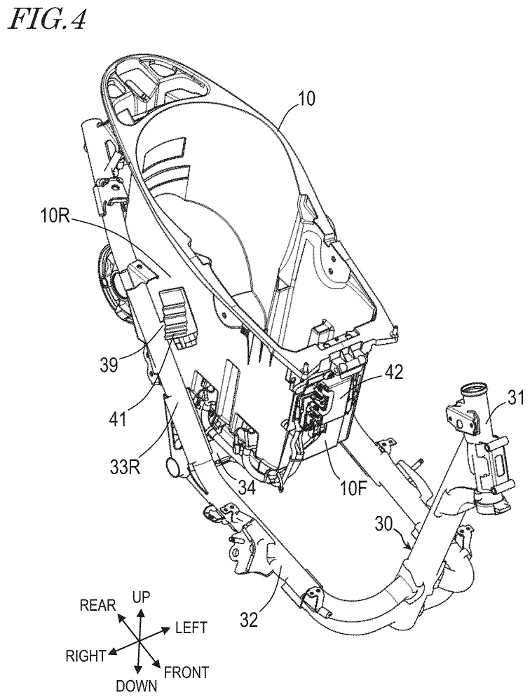

FIG. 3 is a perspective view of the vehicle body frame 30 and the container box 10 as viewed diagonally from the left front. FIG. 4 is a perspective view of the vehicle body frame 30 and the container box 10 as viewed diagonally from the right front. FIGS. 3 and 4 both illustrate the vehicle body frame 30 and the container box 10 as viewed diagonally from above.

As illustrated in FIGS. 2 to 4, the main frame 32 extends from the head pipe 31 rearward and diagonally downward, then extend leftward and rightward, and then extend rearward. The vehicle body frame 30 further includes rear frames 33L and 33R. The rear frame 33L extends from a left rear portion of the main frame 32 rearward and diagonally upward. The rear frame 33R extends from a right rear portion of the main frame 32 rearward and diagonally upward.

A crossing member 34, which extends in a leftward/rightward direction, is provided at a rear portion of the main frame 32 and a front portion of the rear frames 33L and 33R. The crossing member 34 supports a swingarm 17 through a pivot 18 in a manner that allows the swingarm 17 to pivot. An electric motor 47 is provided at a rear portion of the swingarm 17. The electric motor 47 is an in-wheel motor. The rear wheel 4 (FIG. 1) is mounted on the electric motor 47. The electric motor 47 may be either a direct-drive in-wheel motor or a gear-reduction in-wheel motor. The swingarm 17 rotatably supports the rear wheel 4 through the electric motor 47. In this example, the rear wheel 4 is a driving wheel, and the front wheel 3 is a trailing wheel. A rear portion of the rear frame 33L, 33R supports an upper portion of a shock absorber 37 in a manner that allows the shock absorber 37 to oscillate. A lower portion of the shock absorber 37 supports the swingarm 17 in a manner that allows the swingarm 17 to pivot. A motor control unit (MCU) 46 that controls an operation of the electric motor 47 is provided in the swingarm 17.

By providing the electric motor 47 and the MCU 46 on and in the swingarm 17, it is not necessary to allocate a space to arrange the electric motor 47 and the MCU 46 in the inside of the vehicle body 2. Therefore, the flexibility of arrangement of parts other than the electric motor 47 and the MCU 46 is increased.

As illustrated in FIG. 1, a floorboard 6 for the rider's feet is provided between the front wheel 3 and the rear wheel 4 in a forward/rearward direction of the vehicle 1. The floorboard 6 is supported by the main frame 32. A seat 5 on which the rider sits is provided at an upper portion of the vehicle body 2. The seat 5 is located behind and diagonally above the floorboard 6. The container box 10 (FIG. 2) is provided below the seat 5.

The container box 10 is located between the rear frames 33L and 33R in a leftward/rightward direction of the vehicle 1. The container box 10 is supported by the rear frames 33L and 33R and the crossing member 34.

The container box 10 is open upward. The seat 5, which is located on an upper portion of the container box 10, serves as a lid for the container box 10. The seat 5, which serves as a lid for the container box 10, is openable and closeable through, for example, a hinge. The space inside the container box 10 is able to accommodate the rider's baggage, a battery, and the like. In the case in which a battery is contained in the container box 10, a connector 56 (FIG. 3) for connecting the battery is provided in the container box 10.

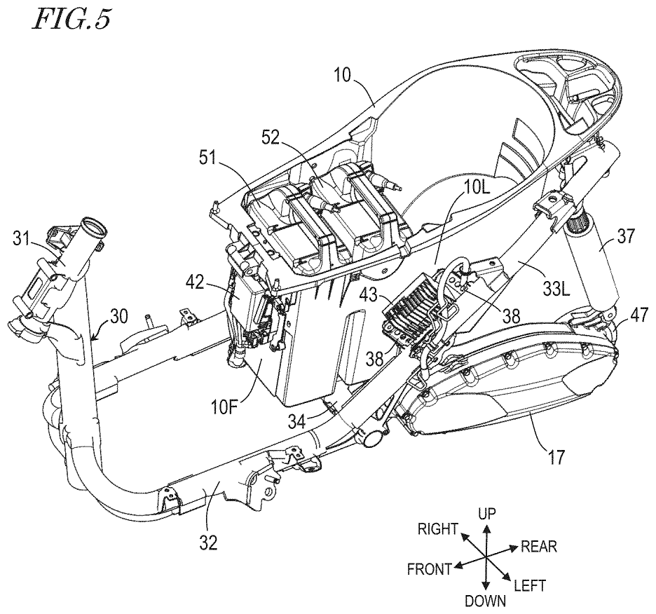

FIG. 5 is a diagram illustrating an example of the container box 10 with batteries contained therein. In the example of FIG. 5, two batteries 51 and 52 are provided in the container box 10. In the case in which a plurality of batteries are contained in the container box 10, a plurality of connectors 56 (FIG. 3) for connecting the batteries are provided. In the example of FIG. 5, a remaining space behind the batteries 51 and 52 is able to accommodate the rider's baggage and the like. The container box 10 may accommodate one or three or more batteries.

The connectors 56 for connecting the batteries 51 and 52 may be located at a position higher than a bottom portion of the container box 10. This substantially prevents the electrode portions of the batteries 51 and 52 and the connectors 56 from getting wet even when water enters the container box 10.

The batteries 51 and 52 may be removably attached to the vehicle 1 without the need of a tool. The batteries 51 and 52, which are removable, are able to be charged by being connected to an external charger with the batteries 51 and 52 removed from the vehicle 1. For example, even when no charging equipment is provided in a parking garage, the batteries 51 and 52 are able to be charged in other places such as at home.

The vehicle body cover 20 (FIG. 1) is shaped to cover the vehicle body frame 30 and the container box 10. The vehicle body cover 20 includes a front cowling 21 and a leg cowling 22, which cover a portion of a front portion of the vehicle 1. A headlamp 7 is provided at a front portion of the front cowling 21.

The vehicle body cover 20 further includes a seat cowling 23 and a rear cowling 24, which cover a portion of a rear portion of the vehicle 1. The seat cowling 23 and the rear cowling 24 covers the container box 10 and the rear frames 33L and 33R.

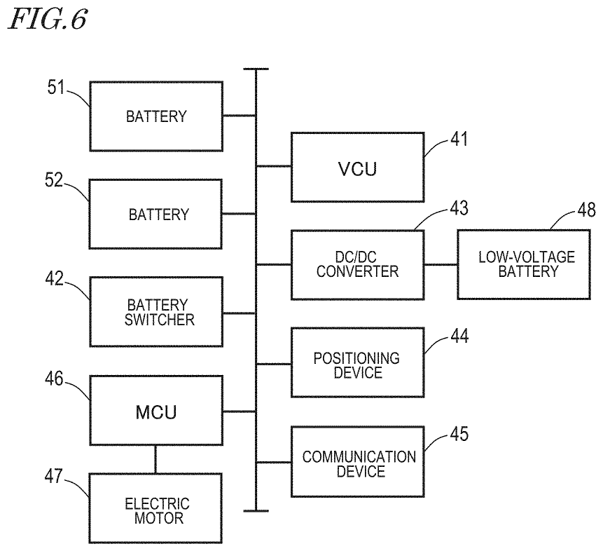

Next, a plurality of electrical components that are provided in the scooter type two-wheeled electric vehicle 1 will be described. FIG. 6 is a block diagram illustrating an example of a plurality of electrical components provided in the scooter type two-wheeled electric vehicle 1. A plurality of electrical components having different functions are provided in the scooter type two-wheeled electric vehicle 1.

A vehicle control unit (VCU) 41 controls operations of the entire scooter type electric vehicle 1. The batteries 51 and 52 output electric power to drive the electric motor 47. The output voltages of the batteries 51 and 52 are each, for example, but not limited to, 50 V. A battery switcher 42 switches a battery that is used between the batteries 51 and 52. The battery switcher 42 is, for example, a relay. The VCU 41 controls an operation of the battery switcher 42 to choose a battery that is used from the batteries 51 and 52. For example, when the state of charge of a battery that is currently used is low, the other battery can replace that battery.

A low-voltage battery 48 supplies electric power to an electrical component that operates with a low voltage. The “low voltage” means a voltage that is lower than the output voltages of the batteries 51 and 52. The low voltage is, for example, but not limited to, 12 V. The low-voltage battery 48 is located, for example, below the floorboard 6 (FIG. 1), or alternatively, may be located at other positions.

The DC/DC converter 43 reduces a voltage received from the battery 51 or 52 through the battery switcher 42, and outputs the reduced voltage. The output voltage of the DC/DC converter 43 is, for example, but not limited to, 12 V. The electric power output by the DC/DC converter 43 is supplied to the low-voltage battery 48, which is in turn charged. The electric power output by the DC/DC converter 43 may be directly supplied to an electrical component that operates with a low voltage.

The motor control unit (MCU) 46 generates a drive current from a current received from the battery 51 or 52 through the battery switcher 42, and outputs the drive current to the electric motor 47. Rotation produced by the electric motor 47 is transmitted to the rear wheel 4, which in turn allows the vehicle 1 to travel.

The positioning device 44 is able to detect a location (geographic coordinates) of the vehicle 1 in a geographic coordinate system. The positioning device 44 receives a GNSS signal transmitted from a GNSS satellite, and determines a position based on the GNSS signal. GNSS collectively refers to satellite-based positioning systems, such as the global positioning system (GPS), the quasi-zenith satellite system (QZSS, for example, Michibiki), GLONASS, Galileo, and BeiDou. Positioning may be performed by any technique that is able to obtain positional information having a required precision. The positioning technique may, for example, be interference positioning or relative positioning. The detection of the geographic coordinates of the vehicle 1 allows displaying of a map indicating the current location of the vehicle 1, or navigation to a destination.

A communication device 45 is used for communication between the vehicle 1 and an external device through a communication network. The communication device 45 may allow wireless communication that uses mobile telephony or satellite communications. When the rider is carrying a mobile router, the communication device 45 may be connected to the mobile router by wired or wireless communication. In that case, the communication device 45 is connected to the communication network through the mobile router. The communication device 45 may communicate with other vehicles, i.e., may perform inter-vehicle communication.

The VCU 41 may be connected to a plurality of electrical components through a bus to control operations of the plurality of electrical components. The VCU 41 may be connected to each electrical component without through a bus.

It should be noted that in the case in which information about the location of the vehicle 1 is not used, the vehicle 1 may not include the positioning device 44. In the case in which the vehicle 1 does not communicate with any external device, the vehicle 1 may not include the communication device 45. In the case in which the vehicle 1 includes only one battery to supply power to the electric motor 47, the vehicle 1 may not include the battery switcher 42.

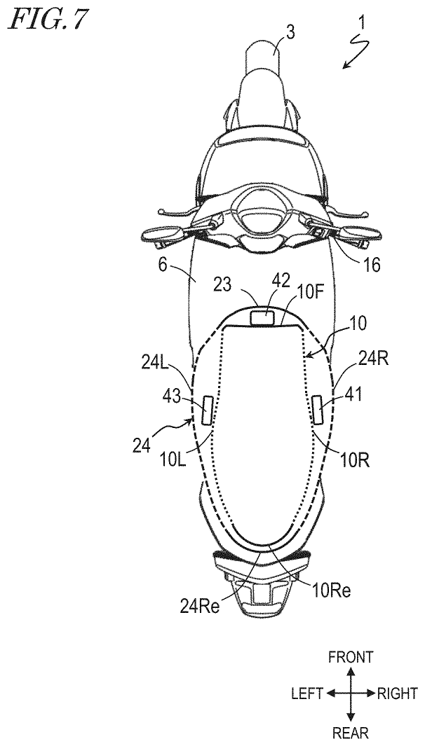

Next, an example of arrangement of a plurality of electrical components will be described. FIG. 7 is a diagram illustrating the container box 10, the seat cowling 23, and the rear cowling 24 as viewed from above.

As illustrated in FIGS. 3, 4, and 7, the container box 10 includes a first front wall 10F, a first left side wall 10L, a first right side wall 10R, and a first rear wall 10Re. The first front wall 10F is located at a front portion of the container box 10, mainly extending in an upward/downward direction and a leftward/rightward direction. The first left side wall 10L is located at a left portion of the container box 10, mainly extending in a forward/rearward direction and an upward/downward direction. The first right side wall 10R is located at a right portion of the container box 10, mainly extending in a forward/rearward direction and an upward/downward direction. The first rear wall 10Re is located at a rear portion of the container box 10, mainly extending in an upward/downward direction and a leftward/rightward direction. In FIG. 7, the first front wall 10F and the first rear wall 10Re are indicated by a solid line, and the first left side wall 10L and the first right side wall 10R are indicated by a dotted line. The first front wall 10F, the first rear wall 10Re, the first left side wall 10L, and the first right side wall 10R may be integral (unitary) or separate.

The rear cowling 24 includes a second left side wall 24L, a second right side wall 24R, and a second rear wall 24Re. The second left side wall 24L is located to the left of the first left side wall 10L of the container box 10 and the rear frame 33L (FIG. 3), covering the first left side wall 10L and the rear frame 33L. The second right side wall 24R is located to the right of the first right side wall 10R of the container box 10 and the rear frame 33R (FIG. 4), covering the first right side wall 10R and the rear frame 33R. The second rear wall 24Re is located behind the first rear wall 10Re of the container box 10, covering the first rear wall 10Re. The second left side wall 24L, the second right side wall 24R, and the second rear wall 24Re may be integral (unitary) or separate.

The seat cowling 23 is located in front of the first front wall 10F of the container box 10, covering the first front wall 10F. The seat cowling 23 defines a second front wall covering the first front wall 10F. In FIG. 7, the second front wall 23 and the second rear wall 24Re are indicated by a solid line, and the second left side wall 24L and the second right side wall 24R are indicated by a dashed line. The rear frame 33L extends through a position between the first left side wall 10L and the second left side wall 24L. The rear frame 33R extends through a position between the first right side wall 10R and the second right side wall 24R.

In the present preferred embodiment, an electrical component is provided at each of a position between the first front wall 10F and the second front wall 23, a position between the first left side wall 10L and the second left side wall 24L, and a position between the first right side wall 10R and the second right side wall 24R.

As an example, the battery switcher 42, which is one of the plurality of electrical components, is located between the first front wall 10F and the second front wall 23. The DC/DC converter 43 is located between the first left side wall 10L and the second left side wall 24L. The VCU 41 is located between the first right side wall 10R and the second right side wall 24R.

The battery switcher 42 is attached to the first front wall 10F using, for example, a fastening device such as a bolt. By attaching the battery switcher 42 to the first front wall 10F, the battery switcher 42 is easily located between the first front wall 10F and the second front wall 23.

The DC/DC converter 43 is attached to the rear frame 33L through, for example, a stay 38. The VCU 41 is attached to the rear frame 33R through, for example, a stay 39. By attaching the DC/DC converter 43 to the rear frame 33L, the DC/DC converter 43 is easily located between the first left side wall 10L and the second left side wall 24L. By attaching the VCU 41 to the rear frame 33R, the VCU 41 is easily located between the first right side wall 10R and the second right side wall 24R.

If an attempt is made to arrange a plurality of electrical components that are mounted on the scooter type two-wheeled electric vehicle 1 all in one place, it is necessary to allocate, in the vehicle 1, a large space to arrange the plurality of electrical components together. In the present preferred embodiment, a plurality of electrical components are arranged at distributed positions, i.e., a position between the first front wall 10F and the second front wall 23, a position between the first left side wall 10L and the second left side wall 24L, and a position between the first right side wall 10R and the second right side wall 24R. Therefore, it is not necessary to allocate, in the vehicle 1, a large single space to arrange a plurality of electrical components all in one place. By utilizing spaces between the container box 10 and the cowlings 23 and 24, a slim volume is able to accommodate all of the electrical components.

A plurality of electrical components are distributed and arranged around the container box 10 so that a distance between each electrical component is relatively short. Therefore, the length of an electrical cable connecting each electrical component is reduced.

In the present preferred embodiment, the batteries 51 and 52 are located in the container box 10. For example, as a large current flows through an electrical component that is provided on an electrical path between the battery 51, 52 and the electric motor 47, an electrical cable connected to such an electrical component has a large cross-sectional area. By providing a plurality of electrical components around the container box 10, the lengths of electrical cables having a large cross-sectional area are reduced, resulting in a reduction in a space to arrange the electrical cables. The reduction in the length of an electrical cable having a large cross-sectional area leads to a reduction in weight and cost.

In addition, as electrical components are located around the container box 10, i.e., at a relatively high position, the electrical components are less likely to get wet even if water on the road surface enters the vehicle 1.

An electrical component provided in front of the container box 10 may have a thickness greater than that of an electrical component provided laterally to the container box 10. Here, the thickness of an electrical component may refer to a length of the electrical component in a direction in which the outer shape of the electrical component is shortest. It is relatively easy to increase a distance between the first front wall 10F and the second front wall 23. Therefore, by locating an electrical component having a greatest thickness in front of the container box 10, a width in a leftward/rightward direction of the rear cowling 24 is reduced.

As illustrated in FIG. 2, the DC/DC converter 43 may be attached to the frame 33L at or behind a center portion Cl of the container box 10 in a forward/rearward direction of the vehicle 1. The center portion Cl of the container box 10 may be a center position of an inside dimension of the container box 10. Likewise, the VCU 41 may be attached to the frame 33R at or behind the center portion Cl of the container box 10. This allows a front left diagonal portion and a front right diagonal portion of the rear cowling 24 covering the container box 10 to be slim, and therefore, a portion for the rider's feet of the scooter type two-wheeled electric vehicle 1 is able to have a simple design.

The rear frames 33L and 33R are shaped to extend rearward and diagonally upward at a position lateral to the container box 10. The DC/DC converter 43 and the VCU 41 are able to be located at a higher position of the vehicle 1 by locating the DC/DC converter 43 and the VCU 41 on the frames 33L and 33R at or behind the center portion Cl. Therefore, the DC/DC converter 43 and the VCU 41 are less likely to get wet even if water on the road surface enters the vehicle 1.

As illustrated in FIG. 3, the DC/DC converter 43 may be located inward of the rear frame 33L in a width direction (leftward/rightward direction) of the vehicle 1. As illustrated in FIG. 4, the VCU 41 may be provided inward of the rear frame 33R in a width direction of the vehicle 1. By locating an electrical component inward of the rear frame 33L, 33R, even if an external force is applied to a side portion of the vehicle 1, the external force is substantially prevented from being applied to the electrical component. In addition, a width in a leftward/rightward direction of the rear cowling 24 is reduced.

Other electrical components may be provided at a position between the first front wall 10F and the second front wall 23, a position between the first left side wall 10L and the second left side wall 24L, and a position between the first right side wall 10R and the second right side wall 24R. For example, the positioning device 44, the communication device 45, the MCU 46, and the like may be provided at such positions. A total of four or more electrical components may be provided at the three positions.

In the foregoing preferred embodiments, the seat cowling 23 and the rear cowling 24 are provided as a cover for covering the container box 10. The seat cowling 23 and the rear cowling 24 may be integral.

The batteries 51 and 52 may not be removable, and may be fixed to the vehicle 1 so that the batteries 51 and 52 cannot be removed. That the batteries 51 and 52 cannot be removed means that, for example, the batteries 51 and 52 are fixed to the vehicle 1 using a bolt and a nut or the like, and therefore, a certain tool is required in order to remove the batteries 51 and 52.

The electric motor 47 is not limited to an in-wheel motor. The electric motor 47 may be located away from the rear wheel 4, and rotation may be transmitted from the electric motor 47 to the rear wheel 4 through a power transmission mechanism.

In the foregoing, illustrative preferred embodiments of the present invention have been described.

A scooter electric vehicle 1 according to a preferred embodiment of the present invention includes a front wheel 3 and a rear wheel 4, an electric motor 47 to receive power supplied from a battery 51, 52 and to drive at least one of the front wheel 3 or the rear wheel 4, a floorboard 6 located between the front wheel 3 and the rear wheel 4 and on which a rider's feet are placed, a seat 5 located behind and diagonally above the floorboard 6 and on which the rider sits, a container box 10 that is located below the seat 5, and includes a first front wall 10F, a first left side wall 10L, and a first right side wall 10R, a cover 20 including a second front wall 23 covering the first front wall 10F, a second left side wall 24L covering the first left side wall 10L, and a second right side wall 24R covering the first right side wall 10R; and a first electrical component 42 located between the first front wall 10F and the second front wall 23, a second electrical component 43 located between the first left side wall 10L and the second left side wall 24L, and a third electrical component 41 located between the first right side wall 10R and the second right side wall 24R.

If an attempt is made to arrange a plurality of electrical components that are mounted on the scooter type electric vehicle 1 all in one place, it is necessary to allocate, in the vehicle 1, a large space to arrange the plurality of electrical components together.

According to a preferred embodiment of the present invention, a plurality of electrical components are arranged at distributed positions including a position between the first front wall 10F of the container box 10 and the second front wall 23 of the cover 20, a position between the first left side wall 10L of the container box 10 and the second left side wall 24L of the cover 20, and a position between the first right side wall 10R of the container box 10 and the second right side wall 24R of the cover 20. Therefore, it is not necessary to allocate, in the vehicle 1, a large space to arrange a plurality of electrical components all in one place. By utilizing spaces between the container box 10 and the cover 20, a slim volume is able to accommodate all of the electrical components.

A plurality of electrical components are distributed and arranged around the container box 10 so that a distance between each electrical component is relatively short. Therefore, the length of an electrical cable connecting between each electrical component is reduced. For example, as a large current flows through an electrical component that is provided on an electrical path between the battery 51, 52 and the electric motor 47, an electrical cable connected to such an electrical component has a large cross-sectional area. By providing a plurality of electrical components around the container box 10, the lengths of electrical cables having a large cross-sectional area are reduced, resulting in a reduction in a space to arrange the electrical cables. The reduction in the length of an electrical cable having a large cross-sectional area leads to a reduction in weight and cost.

As electrical components are located around the container box 10, i.e., at a relatively high position, the electrical components are less likely to get wet even if water on the road surface enters the vehicle 1.

In a preferred embodiment, the batteries 51 and 52 may be located in the container box 10.

As a large current flows through an electrical cable that connects the battery 51, 52 and an electrical component, the electrical cable has a large cross-sectional area. By providing a plurality of electrical components around the container box 10, the lengths of electrical cables having a large cross-sectional area that connect the battery 51, 52 and the electrical components are reduced.

In a preferred embodiment, the batteries 51 and 52 may be removably attached to the scooter type electric vehicle 1.

The batteries 51 and 52 are able to be charged by being connected to an external charger with the batteries 51 and 52 removed from the vehicle 1. For example, even when no charging equipment is provided in a parking garage, the batteries 51 and 52 are able to be charged.

In a preferred embodiment, the first electrical component 42, the second electrical component 43, and the third electrical component 41 may have different functions.

As it is not necessary to allocate in the vehicle 1 a large space to arrange a plurality of electrical components having different functions all in one place, a slim volume is able to accommodate all of the electrical components.

In a preferred embodiment, the first electrical component 42, the second electrical component 43, and the third electrical component 41 may each be any of a control device 41 to control an operation of the scooter type electric vehicle 1, a converter 43 to change the magnitude of the output voltage of the battery 51, 52 and output the resultant voltage, a battery switcher 42 to switch a battery which is used between the batteries 51 and 52, a positioning device 44 to detect a location of the scooter type electric vehicle 1 in a geographic coordinate system, and a communication device 45 to communicate data between the scooter type electric vehicle 1 and an external device.

It is not necessary to allocate, in the vehicle 1, a large space to arrange a plurality of electrical components all in one place, and a slim volume is able to accommodate all of the electrical components.

In a preferred embodiment, the first electrical component 42 located between the first front wall 10F and the second front wall 23 may be thicker than the second electrical component 43 and the third electrical component 41.

It is relatively easy to increase a distance between the first front wall 10F and the second front wall 23. Therefore, by locating an electrical component having a greatest thickness in front of the container box 10, a width in a leftward/rightward direction of the cover 20 covering the container box 10 is reduced.

In a preferred embodiment, the scooter type electric vehicle 1 may further include a frame 33L that extends through a position between the first left side wall 10L and the second left side wall 24L, and a frame 33R that extends through a position between the first right side wall 10R and the second right side wall 24R. At least one of the second electrical component 43 or the third electrical component 41 may be located inward of the frame 33L, 33R in a width direction of the scooter type electric vehicle 1.

Even if an external force is applied to a side portion of the scooter type electric vehicle 1, the external force is substantially prevented from being applied to an electrical component.

In a preferred embodiment, the scooter type electric vehicle 1 may further include a frame 33L that extends through a position between the first left side wall 10L and the second left side wall 24L, and a frame 33R that extends through a position between the first right side wall 10R and the second right side wall 24R. At least one of the second electrical component 43 or the third electrical component 41 may be located on the frame 33L, 33R.

The second electrical component 43 and the third electrical component 41 are easily located between the container box 10 and the cover 20.

In a preferred embodiment, at least one of the second electrical component 43 or the third electrical component 41 may be located at or behind a center portion Cl of the container box 10 in a forward/rearward direction of the scooter type electric vehicle 1.

A front left diagonal portion and a front right diagonal portion of the cover 20 covering the container box 10 is reduced in size, and therefore, a portion for the rider's feet of the scooter type electric vehicle 1 is able to have a simple design.

In a preferred embodiment, the scooter type electric vehicle 1 may further include a frame 33L that extends through a position between the first left side wall 10L and the second left side wall 24L, and a frame 33R that extends through a position between the first right side wall 10R and the second right side wall 24R. The frame 33L, 33R extends rearward and diagonally upward at a position lateral to the container box 10. At least one of the second electrical component 43 or the third electrical component 41 may be located on the frame 33L, 33R at or behind the center portion Cl of the container box 10 in a forward/rearward direction of the scooter type electric vehicle 1.

A front left diagonal portion and a front right diagonal portion of the cover 20 covering the container box 10 are reduced in size, and therefore, a portion for the rider's feet of the scooter type electric vehicle 1 is able to have a simple design.

The second electrical component 43 and the third electrical component 41 are located at a higher position. Therefore, the second electrical component 43 and the third electrical component 41 are less likely to get wet even if water on the road surface enters the vehicle 1.

In a preferred embodiment, the scooter type electric vehicle 1 may further include a swingarm 17 that supports the rear wheel 4. The electric motor 47 may be provided on the swingarm 17.

As it is not necessary to allocate a space to arrange the electric motor 47 in the inside of the vehicle body of the scooter type electric vehicle 1, the flexibility of arrangement of parts other than the electric motor 47 is increased.

In a preferred embodiment, the scooter type electric vehicle 1 may be a scooter type two-wheeled electric vehicle.

In the scooter type two-wheeled electric vehicle 1, a number of parts need to be arranged within a limited space in the vehicle 1, and therefore, a limitation is imposed on the arrangement of the parts. According to a preferred embodiment of the present invention, a plurality of electrical components are arranged at distributed positions including a position between the first front wall 10F of the container box 10 and the second front wall 23 of the cover 20, a position between the first left side wall 10L of the container box 10 and the second left side wall 24L of the cover 20, and a position between the first right side wall 10R of the container box 10 and the second right side wall 24R of the cover 20. By utilizing spaces between the container box 10 and the cover 20, a slim volume is able to accommodate all of the electrical components. Preferred embodiments of the present invention are particularly useful in the field of scooter type electric vehicles including an electric motor as a source of drive power.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electric scooter comprising:
a front wheel and a rear wheel;
an electric motor to receive power from a battery and to drive at least one of the front wheel or the rear wheel;
a floorboard between the front wheel and the rear wheel;
a seat behind and diagonally above the floorboard;
a container box below the seat and including a first front wall, a first left side wall, and a first right side wall;
a cover including a second front wall covering the first front wall, a second left side wall covering the first left side wall, and a second right side wall covering the first right side wall; and
a first electrical component located between the first front wall and the second front wall, a second electrical component located between the first left side wall and the second left side wall, and a third electrical component located between the first right side wall and the second right side wall.

2. The electric scooter according to claim 1, wherein the battery is located in the container box.

3. The electric scooter according to claim 1, wherein the battery is removably attached to the electric scooter.

4. The electric scooter according to claim 1, wherein the first electrical component, the second electrical component, and the third electrical component have different functions.

5. The electric scooter according to claim 1, wherein the first electrical component, the second electrical component, and the third electrical component are each any one of a controller configured or programmed to control an operation of the electric scooter, a converter to change a magnitude of an output voltage of the battery and output the changed voltage, a battery switcher to switch batteries for use, a positioner to detect a location of the electric scooter in a geographic coordinate system, and a communicator to communicate data between the electric scooter and an external device.

6. The electric scooter according to claim 1, wherein the first electrical component is thicker than the second electrical component and the third electrical component.

7. The electric scooter according to claim 1, further comprising:
a frame extending between the first left side wall and the second left side wall and between the first right side wall and the second right side wall; wherein
at least one of the second electrical component or the third electrical component is located inward of the frame in a width direction of the electric scooter.

8. The electric scooter according to claim 1, further comprising:
a frame extending between the first left side wall and the second left side wall and between the first right side wall and the second right side wall; wherein
at least one of the second electrical component or the third electrical component is located on the frame.

9. The electric scooter according to claim 1, wherein at least one of the second electrical component or the third electrical component is located at or behind a center portion of the container box in a forward/rearward direction of the electric scooter.

10. The electric scooter according to claim 1, further comprising:
a frame extending between the first left side wall and the second left side wall and between the first right side wall and the second right side wall; wherein
the frame extends rearward and diagonally upward at a position lateral to the container box; and
at least one of the second electrical component or the third electrical component is located on the frame at or behind a center portion of the container box in a forward/rearward direction of the electric scooter.

11. The electric scooter according to claim 1, further comprising:
a swing arm to support the rear wheel; wherein
the electric motor is provided on the swing arm.

12. The electric scooter according to claim 1, wherein the electric scooter is a two-wheeled electric vehicle.
